(19) United States
(12) Patent Application Publication
(10) Pub. No.: US 2012/0278100 A1
(43) Pub. Date: Nov. 1, 2012

(54) Remote, Adjunct, Credentialed Provider-Directed Healthcare Systems and Methods

(75) Inventor: John Macoviak, La Jolla, CA (US)

(73) Assignee: Annuary Healthcare, Inc., La Jolla, CA (US)

(21) Appl. No.: 13/096,886

(22) Filed: Apr. 28, 2011

(51) Int. Cl. G06Q 50/22

(52) U.S. Cl. 705/3

(57) ABSTRACT

Disclosed herein, in certain embodiments, are systems and methods for extending patient care effectiveness of a licensed primary healthcare provider facility, group, or individual and providing professional answering and triage services, comprising: a live, remote, adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more electronic health records for said one or more patients; and a communications link between said remote adjunct healthcare provider and said patient or one or more onsite patient caregivers.

### BACKGROUND OF THE INVENTION

Many healthcare facilities are understaffed, in some cases located in governmentally-designated underserved areas, and consequently, their healthcare providers, especially physicians are fatigued and overworked. In a recent survey, 76 percent of responding physicians indicated that they were either working at or beyond their maximum capacity. Healthcare providers have a dearth of time during their regular working hours for all but the highest priority tasks. Patient care effectiveness declines when healthcare providers are unavailable to call in elective prescriptions, assess minor ailments, and provide expert consultation. According to a leading health care performance improvement consultancy, on average, a patient walking into an emergency department waits over four hours before being attended by a physician.

At the same time patient care effectiveness declines, healthcare costs are only rising. While more money is spent on health care per person in the U.S. than in any other nation in the world, in 2009, the U.S. Census Bureau reported that 16.7% of the population was uninsured. Current estimates put U.S. health care spending at approximately 16% of GDP. Growth in healthcare spending is projected to average 6.7% annually over the period 2007 through 2017. High healthcare costs also affect individuals. A 2007 study found that 62.1% of filers for bankruptcies cited high medical expenses as a contributing factor.

### SUMMARY OF THE INVENTION

Multiple industries have emerged around the needs of overworked providers and chronically short-staffed healthcare provider facilities and groups. A locum tenens healthcare provider is one who temporarily fulfills the duties of another. Several staffing agencies provide locum tenens health care providers. These services are commonly used, especially in rural and underserved areas; however, this is not a long-term solution for either patient care effectiveness or high healthcare costs because the positions are inherently temporary and the costs are extraordinarily high. Healthcare provider answering services also attempt to relieve overworked providers and short-staffed facilities by acting as a buffer to receive patient contacts during providers' non-working hours. However, these services are not operated by skilled and qualified healthcare providers and therefore cannot extend patient care effectiveness or provide professional triage services.

Technology increasingly offers opportunities to meaningfully address the barriers to patient care effectiveness and to reduce the cost of healthcare. For example, improved communications systems allow healthcare providers to connect with patients across distances. Further, electronic health records (EHRs) enhance the portability and accessibility of patients' medical histories. Despite these opportunities, telemedicine systems have failed to address existing medical requirements including providing remote healthcare providers access to EHRs that are historic or recorded in real-time and providing adequate communications links between remote healthcare providers and patients or onsite patient caregivers. Even more importantly, existing telemedicine systems fail to address existing legal requirements including those surrounding licensure and liability. For example, existing systems fail to provide a remote adjunct healthcare provider who is credentialed by a licensed primary healthcare provider facility, group, or individual specifically to triage and provide remote adjunct care to patients and who is covered by medical malpractice insurance. Accordingly, we have identified a long-felt and unmet need for such a remote, adjunct healthcare system capable of extending patient care effectiveness and providing professional answering and triage services. Accessible remote adjunct healthcare that is legally and medically compliant is a critical factor in addressing healthcare costs.

Disclosed herein, in certain embodiments, are remote healthcare systems for extending patient care effectiveness of a licensed primary healthcare provider facility, group, or individual and providing professional triage services, comprising: a remote adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more EHRs for said one or more patients, wherein said EHRs are historic and/or live; and a communications link between said remote adjunct healthcare provider and said patient or one or more onsite patient caregivers. In some embodiments, the system further comprises a communications link between said remote adjunct healthcare provider and one or more pharmaceutical, diagnostic, or therapeutic service providers. In some embodiments, the system further comprises a communications link between said remote adjunct healthcare provider and one or more live medical, legal, insurance, or financial consultants. In some embodiments, credentialing by said licensed primary healthcare provider facility, group, or individual comprises verifying, where applicable, said remote adjunct provider's prescription license, education, training, certifications, professional references, malpractice insurance coverage, malpractice insurance state, legal license to practice their profession, and state of licensure. In some embodiments, credentialing further comprises one or more live interviews. In some embodiments, credentialing by a licensed primary healthcare provider facility, group, or individual comprises granting admitting privileges. In further embodiments, the admitting privileges include billing privileges. In still further embodiments, the admitting privilege includes the right to admit patients to the facility for a specific diagnostic or therapeutic service. In some embodiments, the admitting privilege to a physician is limited to a consultative service. In other embodiments, the admitting privilege is a right granted to a non-physician to treat patients independently with the appropriate state's required oversight and review of the healthcare protocols used by a legally licensed, credentialed physician to empower the non-physician to execute healthcare. In some embodiments, the system further comprises hardware to biometrically verify said patient's identity. In further embodiments, the system further comprises a software module to biometrically verify said patient's identity. In some embodiments, the remote adjunct care is initiated by said patient, by said onsite patient caregivers, or by said licensed primary healthcare provider facility, group, or individual. In some embodiments, the system further comprises a software module for electronically recording all communications between said remote adjunct healthcare provider and said patient and/or said onsite patient caregivers. In some embodiments, the system further comprises a software module for prediction of a health outcome of a patient or therapy, wherein said prediction is real-time, individualized, and probabilistic-based and uses emerging health data, wherein said software module is adapted for use by said remote adjunct healthcare provider. In further embodiments, said emerging health data includes one or more of: patient-specific severity of illness, provider-specific intensity of service, outcome records for healthcare services provided, and third party data. In some embodiments, said prediction of a health outcome of a patient or therapy includes determination of triage level, determination or specific care required, or determination of a particular healthcare provider that is suited to provide said care. In some embodiments, the system further comprises a software module for prediction of an economic outcome of a patient or therapy, wherein said prediction is real-time, individualized, and probabilistic-based and uses emerging economic data, wherein said software module is adapted for use by said remote adjunct healthcare provider. In further embodiments, said module for prediction of a health or economic outcome suggests a prescription, a therapy, an evaluation, or a referral to a specified type of primary care provider, specialist, or ancillary medical personnel. In still further embodiments, said module for prediction of a health or economic outcome recommends a timeline for carrying out said prescription, therapy, evaluation, or referral. In some embodiments, the remote adjunct healthcare provider is a physician. In other embodiments, the remote adjunct healthcare provider is a non-physician. In further embodiments, the remote adjunct healthcare provider is one or more of the following: a dentist, a physician assistant, a nurse practitioner, a registered nurse, a pharmacist, a chiropractor, an emergency medical technician, a licensed practical nurse, a certified ultrasound technician, a psychologist, a social worker, a military medic, a physical therapist, an occupational therapist, a speech therapist, a radiology technician, a cardiac catheterization technician, a clinical pathology laboratory technician, a medical aesthetician, a licensed medical technologist, a toxicologist consultant, a credentialed medical legal consultant, and a credentialed hospital operations administrator. In some embodiments, the remote adjunct healthcare provider is identified or selected based on one or more of: type of a patient's condition, severity of a patient's condition, a patient's insurance eligibility, or availability of one or more remote adjunct healthcare providers. In some embodiments, the patient is admitted to the healthcare facility. In other embodiments, the patient is not admitted to the healthcare facility. In some embodiments, the remote care, answering, and/or professional triage services are provided in a real-time. In other embodiments, the remote care, answering, and/or professional triage services are provided after a time delay. In some embodiments, the patient authorizes the provider's access to their EHRs. In further embodiments, the authorization meets applicable legal requirements. In still further embodiments, said applicable legal requirement is the Health Insurance Portability and Accountability Act of 1996 and/or The Health Information Technology for Economic and Clinical Health Act of 2009. In some embodiments, the software module for providing said remote adjunct healthcare provider access to one or more EHRs further verifies the remote healthcare provider's identity. In some embodiments, said EHRs are updated by the provider. In some embodiments, the EHRs are live, being generated by an onsite patient caregiver, wherein said observer is present with said patient. In further embodiments, the onsite patient caregiver measures one or more of the patient's vital signs or other biometrics. In still further embodiments, the vital sign or biometric comprises at least one of: body temperature, heart rate, blood pressure, respiratory rate, blood diagnostics such as oxygen saturation, glucose concentration, and blood count, urine diagnostics such as specific gravity, protein, glucose, and blood, other bodily fluid diagnostics, and a diagnostic image or imaging report. In some embodiments, the EHRs are generated by an electronic device, wherein said device is present with the patient. In further embodiments, the electronic device measures one or more of the patient's vital signs or other biometrics. In still further embodiments, the vital sign or biometric comprises at least one of: body temperature, heart rate, blood pressure, respiratory rate, blood diagnostics such as oxygen saturation, glucose concentration, and blood count, urine diagnostics such as specific gravity, protein, glucose, and blood, other bodily fluid diagnostics, and a diagnostic image or imaging report. In some embodiments, the electronic device is a biometric sensor. In other embodiments, the electronic device is a portable imaging device. In other embodiments, the electronic device is a portable auscultation device. In some embodiments, the EHRs comprise at least one of: medical history, medication record, medication history, authenticated physical exam, laboratory test reports, imaging reports, demographics, family history, allergies, adverse drug reactions, illnesses, chronic diseases, hospitalizations, surgeries, immunization status, vital signs, age, weight, Observations of Daily Living (ODLs), insurance benefits, insurance, eligibility, insurance claim information, and billing information. In further embodiments, the EHR includes a laboratory test report comprising at least one of: a pathology report, a blood cell count report, a blood culture report, a urinalysis report, a throat culture report, and a genetic test report. In further embodiments, the EHR includes an imaging report comprising at least one of: an X-ray, a CT scan, a MRI, and an ultrasound. In some embodiments, the communication links enable communication via one or more of: telephone, audio conference, video conference, SMS, MMS, instant message, fax, email, and VoIP. In some embodiments, the communication link between the healthcare provider and the service providers meets applicable legal security standards. In further embodiments, the applicable legal standard is the Health Insurance Portability and Accountability Act of 1996 and/or The Health Information Technology for Economic and Clinical Health Act of 2009. In some embodiments, the system further comprises a software module for accessing patient insurance coverage, eligibility, and deductable information or out-of-pocket payment information and information from said one or more pharmaceutical, diagnostic, or therapeutic service providers to guarantee payment to said service provider.

Also disclosed herein, in certain embodiments, are computer-implemented remote healthcare systems for extending patient care effectiveness of a licensed primary healthcare provider facility, group, or individual and providing professional triage services, comprising: a digital processing device connected to a computer network, wherein said processing device comprises a computer readable storage device and an operating system configured to perform executable instructions; and a computer program, provided to said digital processing device, including executable instructions operable to create a remote healthcare application comprising: a software module for verifying credentials of a remote adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more EHRs for said one or more patients; wherein said EHRs are historic and/or live; and a software module for creating and maintaining a communications link between said remote adjunct healthcare provider and said patient or one or more onsite patient caregivers.

Also disclosed herein, in certain embodiments, are remote healthcare systems for extending patient care effectiveness of a licensed primary healthcare provider facility, group, or individual and providing professional triage services, comprising: a remote adjunct healthcare provider, wherein said adjunct provider is credentialed by a licensed primary healthcare provider facility, group, or individual to provide remote adjunct care for one or more patients, wherein credentialing by said licensed primary healthcare provider comprises verifying, where applicable, said remote adjunct provider's prescription license, education, training, certifications, professional references, malpractice insurance coverage, malpractice insurance state, legal license to practice their profession, and state of licensure, wherein said patients are legally under the care of said licensed primary healthcare provider facility, group, or individual; a software module for providing said remote adjunct healthcare provider access to one or more EHRs for said one or more patients; wherein at least one record is generated by an onsite patient caregiver or an electronic device present with the patient; and a network or a telephonic link between said remote adjunct healthcare provider and said patient or said onsite patient caregiver. In some embodiments, the healthcare system further comprises a network or a telephonic link between said remote adjunct healthcare provider and one or more pharmaceutical, diagnostic, or therapeutic service providers.

Also disclosed herein, in certain embodiments, are methods for extending patient care effectiveness of a licensed primary healthcare provider facility, group, or individual and providing professional triage services, comprising the steps of: credentialing a remote adjunct healthcare provider to provide remote care for one or more patients, wherein said adjunct provider is credentialed by a licensed primary healthcare provider facility, group, or individual, wherein said adjunct provider is covered by medical malpractice insurance, wherein said patients are legally under the care of said licensed primary healthcare provider facility, group, or individual; and providing said remote adjunct healthcare provider with software to access: one or more EHRs for said one or more patients, wherein said EHRs are historic and/or live; and a communications link to said patients or one or more onsite patient caregivers. In some embodiments, the method further comprises the step of providing said remote adjunct healthcare provider with software to access a communications link to one or more pharmaceutical, diagnostic, or therapeutic service providers. In some embodiments, the method further comprises of providing said remote adjunct healthcare provider with software for prediction of a health outcome of a patient or therapy, wherein said prediction is real-time, individualized, and probabilistic-based and uses emerging health data, wherein said software module is adapted for use by said remote adjunct healthcare provider. In some embodiments, the method further comprises the step of providing said remote adjunct healthcare provider with software for prediction of an economic outcome of a patient or therapy, wherein said prediction is real-time, individualized, and probabilistic-based and uses emerging economic data, wherein said software module is adapted for use by said remote adjunct healthcare provider. In further embodiments, said software for prediction of a health or economic outcome suggests a prescription, a therapy, an evaluation, or a referral to a specialist.

Also disclosed herein, in certain embodiments, are computer readable media encoded with a computer program including instructions executable by the operating system of a networked digital processing device, wherein said instructions create a remote healthcare application, wherein said remote healthcare application comprises: a software module for verifying credentials of a live, remote, adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more electronic health records for said one or more patients; wherein said electronic health records are historic and/or live; and a software module for creating and maintaining a communications link between said remote adjunct healthcare provider and said patient or one or more onsite patient caregivers.

### BRIEF DESCRIPTION OF THE DRAWINGS

FIG. 1 shows a non-limiting example of a software architecture for a remote, adjunct, credentialed provider-directed healthcare system 10; in this case, a remote healthcare system including a module for credentialing remote adjunct healthcare providers 20, a module for providing access to EHRs 30, a module for providing communications links 40 between the remote adjunct provider and a patient, onsite caregiver, and/or third parties, and a module for maintaining compliance with data security and privacy requirements 50.

FIG. 2 shows a non-limiting example of a process for utilizing a remote, adjunct, credentialed provider-directed healthcare system such as that exemplified in FIG. 1; in this case, a process including initiation of the system 100, patient verification 110, remote adjunct provider verification 120, access of EHRs 140, establishment of communications links 130, 160, and provision of services 170 such as remote care, answering, or triage services.

### DETAILED DESCRIPTION OF THE INVENTION

Existing answering, triage, and telemedicine systems fail to address important issues of medical effectiveness and legal compliance because they do not offer verification of a live, remote, adjunct healthcare provider who is credentialed by a licensed primary healthcare provider facility, group, or individual specifically to provide remote services to particular patients legally under the care of the primary provider. Moreover, existing systems fail to adequately provide remote healthcare providers with access to relevant EHRs that are historic or recorded in real-time and fail to provide adequate communication links between remote healthcare providers and patients or onsite patient caregivers. Thus, an objective of the systems, products, programs, and methods described herein is to unburden overtaxed primary providers and facilities by connecting specifically credentialed live, remote, adjunct healthcare providers with the patients they are credentialed to serve via robust electronic communications channels. Another objective of the systems, products, programs, and methods described herein is to facilitate professional answering and triage services and patient care effectiveness by providing each live, remote, adjunct healthcare provider with adequate access to specific EHRs for the patients they are credentialed to serve.

Disclosed herein, in certain embodiments, are remote healthcare systems for extending patient care effectiveness of a licensed primary healthcare provider facility, group, or individual and providing professional triage services, comprising: a remote adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more EHRs for said one or more patients, wherein said EHRs are historic and/or live; and a communications link between said remote adjunct healthcare provider and said patient or one or more onsite patient caregivers.

Also disclosed herein, in certain embodiments, are computer-implemented remote healthcare systems for extending patient care effectiveness of a licensed primary healthcare provider facility, group, or individual and providing professional triage services, comprising: a digital processing device connected to a computer network, wherein said processing device comprises a computer readable storage device and an operating system configured to perform executable instructions; and a computer program, provided to said digital processing device, including executable instructions operable to create a remote healthcare application comprising: a software module for verifying credentials of a remote adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more EHRs for said one or more patients; wherein said EHRs are historic and/or live; and a software module for creating and maintaining a communications link between said remote adjunct healthcare provider and said patient or one or more onsite patient caregivers.

Also disclosed herein, in certain embodiments, are remote healthcare systems for extending patient care effectiveness of a licensed primary healthcare provider facility, group, or individual and providing professional triage services, comprising: a remote adjunct healthcare provider, wherein said adjunct provider is credentialed by a licensed primary healthcare provider facility, group, or individual to provide remote adjunct care for one or more patients, wherein credentialing by said licensed primary healthcare provider comprises verifying, where applicable, said remote adjunct provider's prescription license, education, training, certifications, professional references, malpractice insurance coverage, malpractice insurance state, legal license to practice their profession, and state of licensure, wherein said patients are legally under the care of said licensed primary healthcare provider facility, group, or individual; a software module for providing said remote adjunct healthcare provider access to one or more EHRs for said one or more patients; wherein at least one record is generated by an onsite patient caregiver or an electronic device present with the patient; and a network or a telephonic link between said remote adjunct healthcare provider and said patient or said onsite patient caregiver.

Also disclosed herein, in certain embodiments, are methods for extending patient care effectiveness of a licensed primary healthcare provider facility, group, or individual and providing professional triage services, comprising the steps of: credentialing a remote adjunct healthcare provider to provide remote care for one or more patients, wherein said adjunct provider is credentialed by a licensed primary healthcare provider facility, group, or individual, wherein said adjunct provider is covered by medical malpractice insurance, wherein said patients are legally under the care of said licensed primary healthcare provider facility, group, or individual; and providing said remote adjunct healthcare provider with software to access: one or more EHRs for said one or more patients, wherein said EHRs are historic and/or live; and a communications link to said patients or one or more onsite patient caregivers.

Also disclosed herein, in certain embodiments, are computer readable media encoded with a computer program including instructions executable by the operating system of a networked digital processing device, wherein said instructions create a remote healthcare application, wherein said remote healthcare application comprises: a software module for verifying credentials of a live, remote, adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual; a software module for providing said remote adjunct healthcare provider access to one or more electronic health records for said one or more patients; wherein said electronic health records are historic and/or live; and a software module for creating and maintaining a communications link between said remote adjunct healthcare provider and said patient or one or more onsite patient caregivers.

### Various Definitions

As used herein, “adjunct” refers to a healthcare provider who is credentialed by a licensed primary healthcare provider facility, group, or individual to provide remote care for one or more patients who are legally under the care of the primary provider.

As used herein, “remote healthcare,” “remote medicine,” “telehealth,” and “telemedicine” are used interchangeably and refer to the practice of health care delivery, diagnosis, consultation, treatment, transfer of medical data, and education using interactive audio, video, or data communications with a patient, a caregiver, or a healthcare provider.

As used herein, “interactive” refers to audio, video, or data communication involving a real-time (e.g., synchronous) or near real-time (e.g., asynchronous) two-way communication or transfer of data and/or information.

As used herein, “onsite patient caregiver” refers to a person who has an interest in, or responsibility for, the health and welfare of a patient and is present with the patient at least once, intermittently, often, or full-time. Non-limiting examples of onsite patient caregivers include employees of a patient, members of a patient's family, hospice workers, and emergency medical technicians, paramedics, police officers, and firefighters.

### Remote Healthcare System

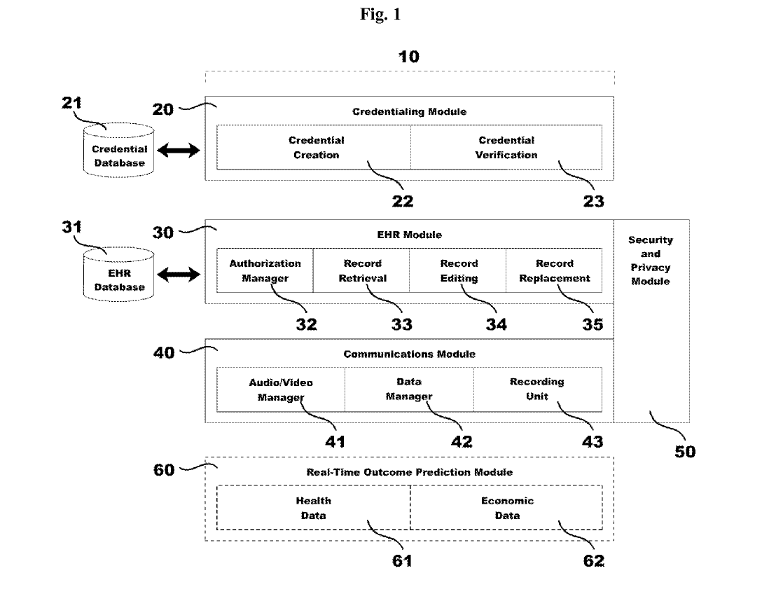

Referring to FIG. 1, in some embodiments, the remote healthcare system 10 comprises a credentialing module 20, an EHR module 30, which is in communication with an EHR database 31, a communications module 40, and a security and privacy module 50. In further embodiments, a credentialing module 20 further comprises sub-modules for credential creation 22 and credential verification 23. In still further embodiments, credentials are stored in and retrieved from a credential database 21, which is in communication with a credentialing module 20. In further embodiments, an EHR module 30 further comprises a sub-module for authorizing access to records 32, which, in some embodiments, verifies the identity of an accessing healthcare provider, a patient, and the legal status of patient authorization. In still further embodiments, an EHR module 30 further comprises a sub-module for retrieving records 33 from an EHR database 31, which is in communication with an EHR module 30 as well as sub-modules for editing 34 and replacing records 35. In some embodiments, an EHR database 30 is internal to the systems described herein. In other embodiments, an EHR database is external and part of a separate electronic healthcare system. In further embodiments, a communications module 40 further comprises sub-modules for managing audio and video content 41 of communications and managing health record data content 42 of communications. In still further embodiments, a communications module 40 further comprises a sub-module for optionally recording communications 43 established and maintained with the systems described herein. In some embodiments, a security and privacy module 50 monitors transactions conducted by an EHR module 30 and a communications module 40 to ensure compliance with data security and patient privacy laws, regulations, and rules. In some embodiments, the system further comprises a real-time outcome prediction module 60, which includes sub-modules for analyzing health data 61 and economic data 62.

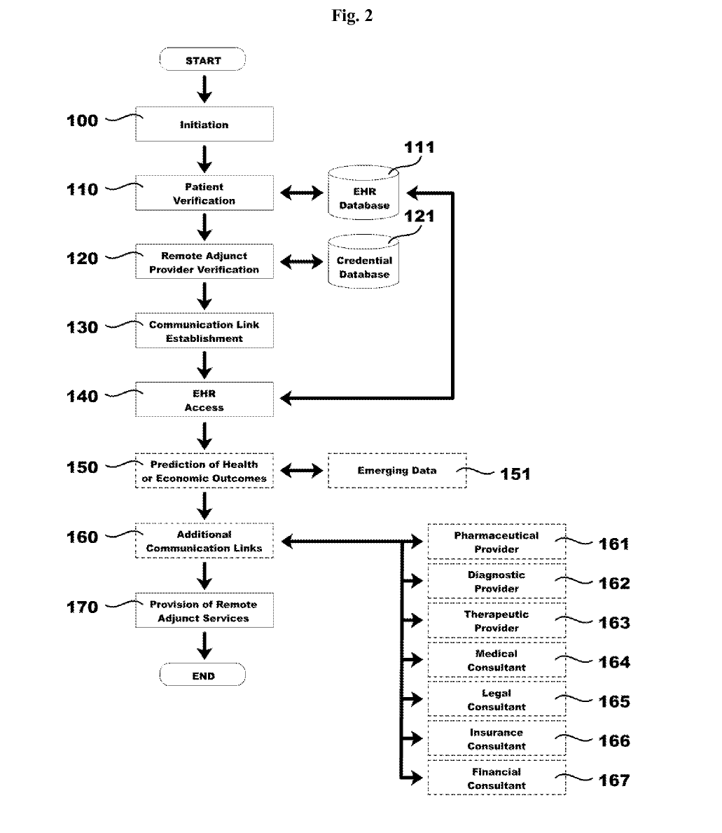

Referring to FIG. 2, in some embodiments, the remote healthcare system exemplified in FIG. 1 is utilized first by initiation of a contact 100. In further embodiments, the system is initiated by, for example, a patient, an onsite caregiver, or a licensed primary healthcare provider facility, group, or individual. Initiation of the system triggers verification processes. In further embodiments, a patient's identity and legal status of care are verified as suitable 110 by consulting, for example, an EHR database 111. Additionally, in further embodiments, a live, remote adjunct provider's identity and credential status are verified as suitable 120 by consulting a credential database 121. Thereafter, in some embodiments, one or more communications links are established 130 and a live, remote, adjunct healthcare provider accesses one or more EHRs pertaining to a patient 140. In further embodiments, one or more communications links are established with a patient or with an onsite patient caregiver. Optionally, in some embodiments, a live, remote, adjunct healthcare provider engages software to make a real-time, individualized, and probabilistic-based prediction of one or more health or economic outcomes of a patient or therapy 150 using emerging data 151. In further embodiments, emerging health or economic data 151 includes, by way of non-limiting examples, patient-specific severity of illness, provider-specific intensity of service, outcome records for healthcare services provided, and third party data. In some embodiments, additional communications links are established and maintained 160 with, for example, healthcare providers and/or consultants. In further embodiments, additional communications links are established and maintained with, by way of non-limiting examples, pharmaceutical providers 161, diagnostic service providers 162, therapeutic providers 163, medical consultants 164, legal consultants 165, health insurance consultants 166, and financial consultants 167. In some embodiments, use of the system culminates in provision of remote adjunct healthcare services 170 that include, for example, answering services, professional triage services, or extension of patent care effectiveness.

In some embodiments, the systems, products, programs, and methods described herein are for extending patient care effectiveness, professional answering, and triage services. In some embodiments, answering services include receiving and sending communications regarding a patient on behalf of a primary healthcare provider facility, group, or individual, where the patient is legally under the care of the primary provider. In some embodiments, triage services include prioritizing communications regarding patients based on the severity of each patient's condition. In further embodiments, prioritization is conducted so as to address as many communications as possible when resources are such that it is impossible or difficult for all communications to be immediately addressed in a responsible way. In some embodiments, extending patient care effectiveness includes, by way of non-limiting examples, the practices of health care delivery, diagnosis, consultation, treatment, transfer of medical information, and education. In further embodiments, these practices are conducted during the non-working hours of a primary healthcare provider for a particular patient. In further embodiments, these practices are conducted when a primary healthcare provider for a particular patient is sick, busy, on vacation, or otherwise unavailable. In still further embodiments, these practices are conducted using interactive audio, video, or data communications with a patient, onsite patient caregiver, healthcare provider, or consultant.

### Live, Remote, Adjunct Healthcare Provider

The systems, products, programs, and methods described herein are used by a live, remote, adjunct healthcare provider. The term “adjunct” describes a healthcare provider who is credentialed by a licensed primary healthcare provider facility, group, or individual to provide remote care for one or more patients who are legally under the care of the primary provider. The term “remote” describes a healthcare provider who is not present with a patient at the time healthcare services are rendered using the inventions described herein.

In some embodiments, the live, remote, adjunct healthcare provider is a physician. In other embodiments, the live, remote, adjunct healthcare provider is a non-physician. In further embodiments, the live, remote, adjunct healthcare provider is, by way of non-limiting examples, a dentist, a physician assistant, a nurse practitioner, a registered nurse, a pharmacist, a chiropractor, an emergency medical technician, a licensed practical nurse, a certified ultrasound technician, a psychologist, a social worker, a military medic, a physical therapist, an occupational therapist, a speech therapist, a radiology technician, a cardiac catheterization technician, a clinical pathology laboratory technician, a medical aesthetician, a licensed medical technologist, a toxicologist consultant, a credentialed medical legal consultant, and a credentialed hospital operations administrator.

In some embodiments, the systems, products, programs described herein are utilized by a plurality of live, remote, adjunct healthcare provider. In further embodiments, a plurality of live, remote, adjunct healthcare provider includes 2, 5, 10, 25, 50, 100, 200, 300, 400, or 500 providers. In further embodiments, a plurality of live, remote, adjunct healthcare providers use the systems simultaneously. In still further embodiments, a live, remote, adjunct healthcare provider is identified or selected for a particular case or contact based on parameters including, by way of non-limiting examples, a patient's condition, disease, or injury, severity of a patient's condition, disease, or injury, a patient's insurance eligibility, or availability of one or more live, remote, adjunct healthcare providers.

In light of the disclosure provided herein, those of skill in the art will recognize that the systems, products, programs described herein are also effectively utilized by other potentially overburdened professionals in need of answering, triage, or client care services. Such professionals, potentially subject to credentialing as described herein include, by way of non-limiting examples, accountants, actuaries, advocates, architects, engineers, financial analysts, judges, law enforcement officers, lawyers, pilots, pharmacists, professors, psychologists, scientists, and veterinarians.

### Credentialing

The systems, products, programs, and methods described herein include, in various embodiments, a software module for verifying the identity and credentials of a live, remote, adjunct healthcare provider. In some embodiments, the software module creates, stores, and retrieves remote adjunct healthcare provider identity and credential records. In some embodiments, the software module verifies a credential issued by a licensed primary healthcare provider facility, group, or individual. In further embodiments, the primary healthcare provider facility, group, or individual is licensed, for example, by one or more U.S. state medical boards, a branch of the U.S. Federal Government (e.g., the Veteran's Administration, Department of Health and Human Services, or the Department of Defense) or a foreign national government. In further embodiments, a credential issued for a live, remote, adjunct healthcare provider to provide remote adjunct care for one or more patients legally under the care of said licensed primary healthcare provider facility, group, or individual. In some embodiments, a patient is admitted to the healthcare facility. In other embodiments, a patient is not admitted to the healthcare facility. In further embodiments, a patient is receiving care as an outpatient or emergency department patient at the healthcare facility.

In some embodiments, the software module verifies a credential issued by a licensed primary healthcare provider facility, group, or individual that indicates the remote adjunct healthcare provider successfully completed a medical and legal screening process. In further embodiments, a screening process includes verification of, by way of non-limiting examples, prescription license, education, training, certifications, professional references, malpractice insurance coverage, malpractice insurance state, malpractice insurance coverage limits, legal license to practice their profession, and state of licensure. In still further embodiments, a screening process includes one or more live interviews of a remote adjunct healthcare provider by a licensed primary healthcare provider facility, group, or individual.

In some embodiments, the software module verifies a credential that indicates a licensed primary healthcare provider facility, group, or individual has granted admitting privileges to a remote adjunct healthcare provider. In further embodiments, admitting privileges include billing privileges. In some embodiments, admitting privileges include the right to admit patients to a facility for a specific diagnostic or therapeutic service. In some embodiments, admitting privileges include the right to admit patients to a facility for a consultative service. In some embodiments, admitting privileges are granted to a non-physician to treat patients independently with the appropriate state's required oversight and review of the healthcare protocols used by a legally licensed, credentialed physician to empower the non-physician to execute healthcare.

In some embodiments, the systems, products, programs, and methods described herein include hardware and a software module to biometrically verify a remote adjunct healthcare provider's identity. In some embodiments, the systems, products, programs, and methods described herein include hardware and a software module to biometrically verify a patient's identity. In some embodiments, the biometric hardware and software is integrated with the software module for verifying the identity and credentials of a live, remote, adjunct healthcare provider. In other embodiments, the biometric hardware and software is not integrated. In further embodiments, the biometric hardware and software is adapted to recognize physiological characteristics including, by way of non-limiting examples, voice, fingerprint, thumbprint, palm print, shape of the face, DNA, hand geometry, iris patterns, retinal patterns, and combinations thereof.

### Electronic Health Records

The systems, products, programs, and methods described herein include a software module for providing a live, remote, adjunct healthcare provider access to one or more EHRs (also known as electronic medical records (EMRs) and electronic patient records (EPRs)) for one or more patients. In some embodiments, the software module enables a live, remote, adjunct healthcare provider to access EHRs without modifying the records. In other embodiments, the software module enables a live, remote, adjunct healthcare provider to access and modify one or more records. In other embodiments, the software module enables a live, remote, adjunct healthcare provider to create EHRs. In further embodiments, the software module enables a live, remote, adjunct healthcare provider to add EHRs to the original storage system. In some embodiments, one or more EHRs are historic, being created prior to access by the systems described herein and electronically stored. In other embodiments, one or more EHRs are live, being created in real-time by an onsite patient caregiver or other medical personnel present with the patient. In some embodiments, the onsite patient caregiver creates an EHR by measuring one or more of a patient's vital signs or other biometrics. In further embodiments, the EHRs are generated by an electronic device, wherein said device is present with the patient. In still further embodiments, the electronic device is, by way of non-limiting examples, a biometric sensor, a portable imaging device, and a portable auscultation device. In some embodiments, a portable electronic device generates medical data or one or more EHRs for a patient and transmits the data or record via one of the communications links provided by the present invention. In other embodiments, a portable electronic device transmits data or records via channels not facilitated by the present invention.

In view of the disclosure provided herein, those of skill in the art will recognize that an EHR is a systematic collection of electronic health information about an individual patient or population. In some embodiments, an EHR includes records of therapies, prescriptions, orders, or instructions issued by a healthcare provider for a patient. EHRs suitable for use with the systems, products, and platforms disclosed herein optionally include a range of data in comprehensive or summary form, including, by way of non-limiting examples, medical history, medication record, medication history, authenticated physical exam, laboratory test reports (e.g., pathology report, blood cell count report, blood culture report, urinalysis report, throat culture report, and genetic test report), imaging reports (e.g., X-ray, CT scan, MRI, and ultrasound), demographics, family history, allergies, adverse drug reactions, illnesses, chronic diseases, hospitalizations, surgeries, immunization status, vital signs and other biometrics (e.g., body temperature, heart rate, blood pressure, respiratory rate, blood diagnostics such as oxygen saturation, glucose concentration, and blood count, urine diagnostics such as specific gravity, protein, glucose, and blood, other bodily fluid diagnostics, and diagnostic images or imaging reports), age, weight, Observations of Daily Living (ODLs), insurance benefits, insurance, eligibility, insurance claim information, and billing information.

In some embodiments, the software module for providing a live, remote, adjunct healthcare provider access to one or more EHRs for one or more patients is further configured to access patient insurance coverage, eligibility, and deductable information or out-of-pocket payment information. In further embodiments, the software module additionally accesses information from one or more pharmaceutical, diagnostic, or therapeutic service providers to guarantee payment to the provider. In other embodiments, the systems, products, programs, and methods described herein further comprise a separate software module to access patient insurance coverage, eligibility, and deductable information or out-of-pocket payment information and information from one or more pharmaceutical, diagnostic, or therapeutic service providers to guarantee payment to the provider.

In some embodiments, a patient authorizes a live, remote, adjunct healthcare provider to access their health records. In further embodiments, the systems, products, programs, and methods described herein include a software module for verifying a patient's authorization for a live, remote, adjunct healthcare provider to access their health records. In some embodiments, the authorization meets applicable legal requirements. In further embodiments, the applicable legal requirements include, by way of non-limiting examples, those in the Health Insurance Portability and Accountability Act of 1996 and the Health Information Technology for Economic and Clinical Health Act of 2009. In some embodiments, the software module for verifying a patient's authorization for a live, remote, adjunct healthcare provider to access their health records is further configured to verify a live, remote, adjunct healthcare provider's identity.

In view of the disclosure provided herein, those of skill in the art will recognize that suitable EHRs include those created and maintained in accordance with published standards, including XML-based standards such as Continuity of Care Record (CCR). Suitable EHRs also include those utilizing the DICOM communications protocol standard for representing and transmitting radiology (and other) image-based data, the HL7 standardized messaging and text communications protocol, and ANSI X12 transaction protocols for transmitting patient and billing data. Additionally, those in the art will recognize that suitable EHRs include those operable with open standard specifications that describe the management, storage, retrieval, and exchange of health data, such as openEHR (available at http://www.openehr.org/).

### Communications Link

The systems, products, programs, and methods described herein include one or more communications links. In some embodiments, the systems, products, programs, and methods described herein include one, two, three, four, five, six, seven, eight, nine, ten, or more communications links. In further embodiments, multiple communications links are created and maintained serially, or one at a time, in a patient care, answering, or triage service session. In other embodiments, multiple communications links are created and maintained in parallel, or simultaneously, in a patient care, answering, or triage service session. In some embodiments, a communications link is created and maintained by a software module. In various embodiments, communication links enable communication via, by way of non-limiting examples, telephone, push-to-talk, audio conference, video conference, SMS, MMS, instant message, Internet bulletin board, blog, microblog, fax, Internet fax, electronic mail, VoIP, or combinations thereof. In some embodiments, one or more communications links are interactive and provide real-time (e.g., synchronous) or near real-time (e.g., asynchronous) two-way communication or transfer of data and/or information.

In some embodiments, the communications link enables a live, remote, adjunct healthcare provider to communicate with one or more other parties and vice versa. In some embodiments, the communications link is between a live, remote, adjunct healthcare provider and a patient or a group of patients. In some embodiments, the communications link is between a live, remote, adjunct healthcare provider and an onsite patient caregiver or group of caregivers. In further embodiments, an onsite patient caregiver is a person who has an interest in, or responsibility for, the health and welfare of a patient and is present with the patient at least once, intermittently, often, or full-time. Non-limiting examples of onsite patient caregivers include an employee of a patient, a member of a patient's family, a physician, a dentist, a physician assistant, a nurse practitioner, a registered nurse, a pharmacist, a chiropractor, a licensed practical nurse, a certified ultrasound technician, radiology technician, a psychologist, a social worker, a physical therapist, an occupational therapist, a speech therapist, a cardiac catheterization technician, a clinical pathology laboratory technician, a medical aesthetician, a licensed medical technologist, a hospice worker, an emergency medical technician, a paramedic, a police officer, and a firefighter. In further embodiments, an onsite patient caregiver communicates with a live, remote, adjunct healthcare provider on behalf of a patient or to describe the condition of the patient. In some embodiments, the communications link is between a live, remote, adjunct healthcare provider and one or more medical product or service providers including, by way of non-limiting examples, pharmaceutical product providers, diagnostic service providers, and therapeutic service providers. In further embodiments, a live, remote, adjunct healthcare provider communicates with one or more medical product or service providers regarding products or services that are prescribed or recommended for a patient or the costs associated with such products or services. In some embodiments, the communications link is between a live, remote, adjunct healthcare provider and one or more consultants including, by way of non-limiting examples, medical consultants, legal consultants, insurance consultants, and financial consultants. In further embodiments, a live, remote, adjunct healthcare provider communicates with one or more medical consultants regarding a patient's medical history, diagnosis, past, current, or contemplated therapies, or prognosis. In further embodiments, a live, remote, adjunct healthcare provider communicates with one or more legal consultants regarding compliance with applicable laws, regulations, and rules. In further embodiments, a live, remote, adjunct healthcare provider communicates with one or more insurance and financial consultants regarding a patient's eligibility, coverage, benefits, deductable, or payment status. In still further embodiments, multiple communications links are established with a plurality of providers and/or consultants to form a conference to remotely discuss the care of one or more patients.

In some embodiments, the systems, products, programs, and methods described herein further comprise a software module for electronically recording communications conducted over one or more communications links. In further embodiments, the audio, video, and health record data exchanged are recorded. In still further embodiments, recorded communications are used to ensure sound medical policies and procedures and compliance with applicable laws, regulations, and rules.

In some embodiments, the communication links meet applicable legal data security standards. In some embodiments, the communication links meet applicable legal patient privacy standards. In further embodiments, the applicable legal standards include, by way of non-limiting examples, the Health Insurance Portability and Accountability Act of 1996 and The Health Information Technology for Economic and Clinical Health Act of 2009. In some embodiments, live and/or recorded electronic communications are encrypted. In further embodiments, cryptographic protocols such as Secure Sockets Layer (SSL) or Transport Layer Security (TLS) are applied to Internet-based communications such as web traffic, electronic mail, Internet faxing, instant message, and VoIP.

### Software to Supplement the Judgment of a Live, Remote, Adjunct Provider

In some embodiments, the systems, products, programs, and methods described herein include a software module for supplementing the professional judgment of a live, remote, adjunct healthcare provider. In light of the disclosure provided herein, those of skill in the art will recognize that appropriate software includes, by way of non-limiting examples, software configured to perform statistical analysis, to perform probability calculations, to make recommendations, and to make outcome predictions. In some embodiments, the software module utilizes aspects of artificial intelligence, neural networks, and/or Bayesian networks.

In some embodiments, the systems, products, programs, and methods described herein include a software module for performing statistical analysis, performing probability calculations, making recommendations, and making outcome predictions based on empirical data gained by means of observation or experiments. In still further embodiments, the software module is an empirical decision making mechanism that utilizes, for example, published medical practice guides and decision flow charts. In still further embodiments, the software module performs meta-analysis of published, peer-reviewed literature to formulate guidelines and protocols for a live, remote, adjunct healthcare provider to optimally deliver services to patients.

In some embodiments, the systems, products, programs, and methods described herein include a software module for performing statistical analysis, performing probability calculations, making recommendations, and making outcome predictions based, in whole or in part on, emerging health or economic data, for example, timely, non-historic data. In further embodiments, emerging health or economic data includes, by way of non-limiting examples, patient-specific parameters, provider-specific parameters, and third party data. In still further embodiments, emerging patient-specific parameters include, by way of non-limiting examples, severity of illness, real-time vital signs, and current symptoms. In still further embodiments, emerging provider-specific parameters include, by way of non-limiting examples, intensity of services required and resources currently available. In still further embodiments, emerging third-party data is sourced from, by way of non-limiting examples, third party commercial healthcare payers or providers, pharmaceutical companies, private medical centers, professional healthcare societies or associations, economic or healthcare databases, Medicare bulletins, U.S. Centers for Disease Control and Prevention (CDC) announcements, U.S. Federal Drug Administration (FDA) announcements, other domestic or foreign government communications, and medical conventions wherein new emerging information may have been announced but not yet published in medical journals for peer review. In some embodiments, the emerging health or economic data refers to data obtained from urgent news and/or announcements distributed in public media. In some embodiments, the emerging health or economic data is derived from a source that has not been peer reviewed by one or more healthcare or economic professionals. In other embodiments, the emerging health or economic data is derived from a source that has been peer reviewed by one or more healthcare or economic professionals. In some embodiments, the emerging health or economic data is derived from a source that has not been published. In other embodiments, the emerging health or economic data is derived from a source that has been published.

In a particular embodiment, the systems, products, programs, and methods described herein include a software module for prediction of a health or economic outcome of a specific patient or therapy, wherein the prediction is real-time, individualized to a particular patient, probabilistic-based, and uses historic, peer-reviewed data and, at least in part, more timely and recent emerging health or economic data. In further embodiments, the software module for prediction of a health or economic outcome is configured to determine of the sufficiency of a model set that was transformed from emerging health or economic data that was acquired in real-time by comparing the model set against previously accumulated internal data for sufficiency and if necessary prompting for additional data until a preferred confidence level is achieved. For example, in some embodiments, a sufficiency of a model set is determined by comparing the model set to a preferred confidence level from known acceptable data. In some embodiments, the software module for prediction of a health or economic outcome is configured to use a statistical model to analyze a model set that was transformed from emerging health or economic data that was acquired in real-time. For example, in some embodiments, the statistical model is any appropriate type of mathematical or physical model indicating interrelationships between input parameters and output parameters. In some embodiments, the statistical model is based on one or more of the following: a linear model; a logistic regression; a classification and regression tree; a random forest; a multivariate adaptive regression spline; or a support vector machine. In some embodiments, the software module for prediction of a health or economic outcome is configured to enhance predictive accuracy by comparing an expected result or outcome of a patient or healthcare provider to an actual result or outcome of a patient or healthcare provider to train, re-train, or validate one or more statistical models.

In some embodiments, the software module for performing statistical analysis, performing probability calculations, making recommendations, and making outcome predictions suggests a prescription, a therapy, an evaluation, or a referral to a specified type of primary care provider, specialist, or ancillary medical personnel. In further embodiments, the software module further recommends a timeline for carrying out a prescription, therapy, evaluation, or referral. In further embodiments, a prediction of a health or economic outcome is used to select a live, remote, adjunct healthcare provider from among a group of qualified providers.

In some embodiments, the software module for performing statistical analysis, performing probability calculations, making recommendations, and making outcome predictions is adapted for use by a live, remote, adjunct healthcare provider. In further embodiments, a live, remote, adjunct healthcare provider uses such a software module in providing answering services by using a prediction to determine the urgency of a communication and/or the identity of one or more primary healthcare providers to contact. In further embodiments, a live, remote, adjunct healthcare provider uses such a software module in providing triage services by using a prediction to determine the severity of a patient's condition, disease, or injury. In further embodiments, a live, remote, adjunct healthcare provider uses such a software module in extending patient care effectiveness by using a prediction to provide a prescription, a therapy, an evaluation, or a referral to a specified type of primary care provider, specialist, or ancillary medical personnel. In still further embodiments, a live, remote, adjunct healthcare provider uses a prediction to recommend a timeline for carrying out a prescription, therapy, evaluation, or referral.

### Digital Processing Device

The systems, products, programs, and methods described herein include a digital processing device. The digital processing device includes one or more hardware central processing units (CPU) that carry out the device's functions. The digital processing device further comprises an operating system configured to perform executable instructions. In some embodiments, the digital processing device further comprises a memory device, a display, an input device, and optionally a sound output device. In some embodiments, the digital processing device is connected to the Internet such that it accesses the World Wide Web. In other embodiments, the digital processing device is connected to an intranet. In other embodiments, the digital processing device is connected to a data storage device. In some embodiments, the digital processing device is a non-portable device, such as a server or a desktop computer. In other embodiments the digital processing device is a portable device, such as a laptop or tablet computer. In other embodiments the digital processing device is a mobile device, such as a smartphone or digital music player.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the digital processing device includes a memory device. The memory is one or more physical apparatus used to store data or programs on a temporary or permanent basis. In some embodiments, the memory is volatile and requires power to maintain stored information. In some embodiments, the memory is non-volatile and retains stored information when the digital processing device is not powered.

In some embodiments, the digital processing device includes a visual display. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

In some embodiments, the digital processing device includes an input device. In some embodiments, the input device is a keyboard or keypad. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the digital processing device optionally includes a sound output device. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

In accordance with the description provided herein, suitable digital processing devices include, by way of non-limiting examples, server computers, desktop computers, laptop computers, notebook computers, tablet computers, netbook computers, smartbook computers, subnotebook computers, ultra-mobile PCs, handheld computers, personal digital assistants, Internet appliances, smartphones, music players, and portable video game systems. Those of skill in the art will recognize that many mobile smartphones are suitable for use in the system described herein. Suitable tablet computers include those with booklet, slate, and convertible configurations, known to those of skill in the art. Suitable portable video game systems include, by way of non-limiting examples, Nintendo DS™ and Sony® PSP™.

### Computer Network

The systems, products, programs, and methods disclosed herein include a digital processing device that is optionally connected to a computer network. A computer network is a collection of computers and/or devices interconnected by communications channels that facilitate communications among users and allow users to share resources. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program and/or mobile application is provided to the digital processing device via the Web. In still further embodiments, the Internet provides access to the World Wide Web and the computer program and/or mobile application is provided to the digital processing device via cloud computing. In other embodiments, the computer network comprises data storage devices including, by way of non-limiting examples, CD-ROMs, DVDs, flash memory devices, solid state memory, magnetic disk drives, magnetic tape drives, optical disk drives, cloud computing systems and services, and the like. In further embodiments, the computer program and/or mobile application is provided to the digital processing device via a data storage device.

### Computer Readable Medium

In some embodiments, the systems, products, programs, and methods disclosed herein include one or more computer readable media encoded with a program including instructions executable by the operating system of an optionally networked digital processing device, wherein said instructions create a social shopping networking service. In further embodiments, a computer readable medium is a tangible component of a digital processing device. In still further embodiments, a computer readable medium is optionally removable from a digital processing device. In some embodiments, a computer readable medium includes, by way of non-limiting examples, CD-ROMs, DVDs, flash memory devices, solid state memory, magnetic disk drives, magnetic tape drives, optical disk drives, cloud computing systems and services, and the like.

### Computer Program

The systems, products, programs, and methods disclosed herein include at least one computer program. The computer program includes a sequence of instructions, executable in the digital processing device's CPU, written to perform a specified task. Those of skill in the art will recognize that the computer program may be written in various versions of various languages. In some embodiments, the computer program comprises one sequence of instructions. In some embodiments, the computer program comprises a plurality of sequences of instructions. In some embodiments, the computer program is delivered from one location. In other embodiments, the computer program is delivered from a plurality of locations. In various embodiments, the computer program includes one or more software modules. In various embodiments, the computer program includes, in part or in whole, one or more web applications, one or more mobile applications, one or more standalone applications, one or more web browser plug-ins, extensions, add-ins, or add-ons, or combinations thereof.

### Web Application

In some embodiments, the computer program includes a web application written in one or more markup languages, style languages, client-side scripting languages, server-side coding languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a style language such as Cascading Style Sheets (CSS). In some embodiments, the computer program is written to some extent in a client-side scripting language such as Asynchronous Javascript and XML (AJAX), Actionscript, Javascript, or Silverlight®. In some embodiments, the computer program is written to some extent in a server-side coding language such as Active Server Pages (ASP), ColdFusion®, Common Gateway Interface (CGI), Perl, Java™, Hypertext Preprocessor (PHP), Python™, Ruby, Structured Query Language (SQL), mySQL™, Oracle®, or .NET.

### Mobile Application

In some embodiments, the computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, the mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Those of skill in the art will also recognize that mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, the computer program includes a standalone application, which is a program that is run as an independent computer process, not an add-on to an existing process, e.g. not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Visual Basic, and VB .NET, or combinations thereof. Compilation is often performed, at least in part, to create an executable program. In some embodiments, the computer program includes one or more executable complied applications.

### Software Modules

The systems, products, programs, and methods disclosed herein include, in various embodiments, software, server, and database modules. In view of the disclosure provided herein, the software modules are created by techniques known to those of skill in the art using machines, software, and languages known to the art. The software modules disclosed herein are implemented in a multitude of ways. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In some embodiments, software modules are hosted on one or more machines in one location. In other embodiments, software modules are hosted on one or more machines in more than one location.

### EXAMPLES

The following illustrative examples are representative of embodiments of the systems, products, programs, and methods described herein and are not meant to be limiting in any way.

### Example 1

A 50-year-old, male patient experiences shortness of breath after a leisurely walk on a Saturday morning. He has experienced prior heart problems so he immediately calls his cardiologist. Unfortunately, his cardiologist does not regularly see patients on weekends. However, the cardiologist's group has partnered with a professional triage answering service to provide a professional answering service during non-working hours. During non-working hours, calls are directed to a nurse practitioner (NP) who can provide basic medical care. The cardiologist's group had previously verified the NP's credentials by interviewing the NP and checking her medical malpractice insurance coverage, professional references, legal and prescription licenses, and state of licensure. The NP answers the patient's call and notes the symptoms. Using a software program, the NP accesses the group's electronic health records including the patient's previous medical history.

The NP supplements her professional judgment by entering the circumstances of the emerging situation and importing the patient's historic health records into a software program designed to make real-time predictions of health outcomes of a patient and potential therapies utilizing statistical analysis of emerging data. The software determines the probability that the condition is a mild allergic reaction to pollen in which the software recommends prescribing an oral anti-histamine. The software also determines the probability that the condition is an asthma attack in which the software recommends prescribing a bronchodilator and employing a remote, portable auscultation device to record and transmit the patient's breath sounds to check for wheezing. And, the software also determines the probability that the condition is more severe and the live, remote, adjunct healthcare provider should call 911 in the patient's jurisdiction.

Based on the symptoms provided, the medical history, and the probabilistic outcome predictions, the NP triages the patient, determining the medical severity of illness, the intensity of service required, who should perform required services, and recommended timeline of events. The NP instructs the patient on the next course of action, which is an immediate prescription for a bronchodilator, updates the patient's history in the group's electronic health records, and notifies the patient's cardiologist that a follow-up call is in order. A software program records all of the communications electronically for later review. The total elapsed time of the session is less than 10 minutes.

### Example 2

A 25-year-old female researcher in Antarctica is experiencing coughing and fever. The nearest medical facility is at least few hundred miles away. The research station is only equipped to provide basic first aid care and medication. However, the station is partnered with a live, remote, adjunct triage system and equipped with a biometric sensor and a portable, electronic imaging device. The researcher suspects that she has contracted pneumonia, which usually requires immediate treatment, but she is not sure. Using a video conference system, the researcher connects to a live, remote, adjunct provider. The provider, a physician assistant (PA) located in California, is credentialed by the researcher's healthcare provider who verified the PA's education, training, certifications, references, prescription license, malpractice insurance coverage, and state license and state of licensure. The PA asks basic questions about the researcher's symptoms and examines the researcher visually. To gather additional information, the PA instructs the researcher to use the biometric sensor and the electronic imaging device equipped in the station. The biometric sensor measures the researcher's vital signs and other biometric data such as her body temperature, heart rate, blood pressure, and respiratory rate. Using the portable imaging device, another researcher takes a chest x-ray.

The PA obtains the researcher's consent to access her electronic health records. Using a software program, which is updated regularly to meet applicable legal requirements, the PA accesses the researcher's medical history, medication history, family history, and other relevant information.

At the same time, the above data are transmitted to another software program designed to predict a health outcome of a patient. The prediction is real-time, individualized, and probabilistic-based, and it uses an emerging health data. The software determines the triage level, specific care required and the nearest healthcare provider suited for the care. The software further suggests a prescription and a referral to a specialist. The PA validates the result from the prediction software using his professional judgment and determines that immediate care is needed.

### Example 3

In order to extend its patient care effectiveness, a large metropolitan hospital has recently decreased its overnight medical staff to a minimum level and instituted a live, remote, adjunct triage service system to evaluate any overnight, in-patient care issues. A 33-year-old male is an in-patient of the hospital. Shortly after 2 a.m., he starts experiencing sharp pain in his abdomen. An attendant on duty initiates the remote adjunct triage system by identifying the patient and describing the symptoms briefly into a laptop computer at the patient's bedside. The system analyzes the data and opens a video link with a live, remote, adjunct physician assistant (PA) in Australia. The PA was previously credentialed by the hospital which verified the PA's education, training, certifications, references, prescription license, malpractice insurance coverage, and state license and state of licensure.

The PA obtains the patient's consent to access his electronic health records. Using a software program, the PA accesses the patient's medical history, medication history, family history, and other relevant information. The software is updated regularly to meet applicable legal standards. The attendant on duty measures the patient's vital signs and other biometrics and updates the patient's electronic health records. The PA is very concerned and convenes a remote, live consultative panel comprised of physicians licensed in the patient's state or elsewhere (and not necessarily credentialed by the patient's primary healthcare provider) including a gynecologist, a urologist, and a general surgeon to arrive at a consensus recommendation for the optimal plan of care.

Based on the consensus recommendation, the PA orders an ultrasound. Using a portable imaging device, the attendant takes an ultrasound image of the patient, and the result is directly sent to a radiologist in Switzerland. At 5:43 a.m., the radiologist in Switzerland presents her findings to the PA over a VoIP connection. By this time, the patient's pain has subsided, and the PA prescribes pain medicine for the patient in case the pain returns. The prescription is directly updated into the electronic health records. The result is a patient that is well cared for while the patient's primary physicians are undisturbed during their non-working hours.

At 8:00 a.m. the next morning, the patient is stable and ready for discharge, however it is anticipated that the patient's primary physician will be unavailable to evaluate the patient due to the another urgent situation. A hospital staff member again initiates contact with a live, remote, adjunct healthcare provider who authorizes the patient's discharge home and electronically contacts the patient's preferred pharmacy with medication prescriptions. The result is prevention of an unnecessarily prolonged length of stay and a bed in the hospital being opened to other patients in need sooner.

What is claimed is:

1. A computer-implemented remote healthcare system for extending patient care effectiveness of a licensed primary healthcare provider facility, group, or individual and providing professional triage services, comprising:
(a) a digital processing device connected to a computer network, wherein said processing device comprises a computer readable storage device and an operating system configured to perform executable instructions; and
(b) a computer program, provided to said digital processing device, including executable instructions operable to create a remote healthcare application comprising:
(i) a software module for verifying credentials of a live, remote, adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual;
(ii) a software module for providing said remote adjunct healthcare provider access to one or more electronic health records for said one or more patients; wherein said electronic health records are historic or live; and
(iii) a software module for creating and maintaining a communications link between said remote adjunct healthcare provider and said patient or one or more onsite patient caregivers.

2. The system of claim 1, further comprising a communications link between said remote adjunct healthcare provider and one or more pharmaceutical, diagnostic, or therapeutic service providers.

3. The system of claim 1, further comprising a communications link between said remote adjunct healthcare provider and one or more live medical, legal, insurance, or financial consultants.

4. The system of claim 1, wherein credentialing by said licensed primary healthcare provider facility, group, or individual comprises verifying, where applicable, said remote adjunct provider's prescription license, education, training, certifications, professional references, malpractice insurance coverage, malpractice insurance state, legal license to practice their profession, and state of licensure.

5. The system of claim 1, wherein credentialing by a licensed primary healthcare provider facility, group, or individual comprises granting admitting privileges and/or billing privileges.

6. The system of claim 1, wherein the software module for verifying credentials of a remote adjunct healthcare provider verifies, where applicable, said remote adjunct provider's prescription license, education, training, certifications, professional references, malpractice insurance coverage, malpractice insurance state, legal license to practice their profession, and state of licensure.

7. The system of claim 1, further comprising hardware and software to biometrically verify said patient's identity.

8. The system of claim 1, wherein remote adjunct care is initiated by said patient, by said onsite patient caregivers, or by said licensed primary healthcare provider facility, group, or individual.

9. The system of claim 1, further comprising a software module for electronically recording all communications between said remote adjunct healthcare provider and said patient and/or said onsite patient caregivers.

10. The system of claim 1, further comprising a software module for performing statistical analysis, performing probability calculations, making recommendations, and making outcome predictions, wherein said software module is adapted for use by said live, remote, adjunct healthcare provider, wherein said software module supplements the professional judgment of said live, remote, adjunct healthcare provider.

11. The system of claim 10, wherein said software module recommends a triage level, specific care required, or a particular healthcare provider that is suited to provide said care.

12. The system of claim 10, wherein said software module suggests a prescription, an evaluation, a therapy, or a referral to a specified type of primary care provider, specialist, or ancillary medical personnel.

13. The system of claim 10, wherein said software module for performing statistical analysis, performing probability calculations, making recommendations, and making outcome predictions predicts a health or economic outcome of a patient or therapy, wherein said prediction is real-time, individualized, and probabilistic-based and uses historic, peer-reviewed health or economic data and emerging health or economic data.

14. The system of claim 13, wherein said emerging health data includes one or more of: patient-specific severity of illness, provider-specific intensity of service, outcome records for healthcare services provided, and third party data.

15. The system of claim 1, wherein the remote adjunct healthcare provider is a physician.

16. The system of claim 1, wherein the remote adjunct healthcare provider is a non-physician.

17. The system of claim 1, wherein said remote adjunct healthcare provider is identified or selected based on one or more of: type of a patient's condition, severity of a patient's condition, a patient's insurance eligibility, or availability of one or more remote adjunct healthcare providers.

18. The system of claim 1, wherein the patient is admitted to the healthcare facility.

19. The systems of claim 1, wherein the patient is not admitted to the healthcare facility.

20. The system of claim 1, wherein the patient authorizes the provider's access to their electronic health records.

21. The system of claim 1, wherein the software module for providing said remote adjunct healthcare provider access to one or more electronic health records further verifies the remote healthcare provider's identity.

22. The system of claim 1, wherein the electronic health records are generated by an electronic device, wherein said device is present with the patient.

23. The system of claim 22, wherein the electronic device is a biometric sensor, portable imaging device, or portable auscultation device.

24. The system of claim 1, wherein the communication links enable communication via one or more of: telephone, push-to-talk, audio conference, video conference, SMS, MMS, instant message, Internet bulletin board, blog, microblog, fax, Internet fax, electronic mail, and VoIP.

25. Computer readable media encoded with a computer program including instructions executable by the operating system of a networked digital processing device, wherein said instructions create a remote healthcare application, wherein said remote healthcare application comprises:
(i) a software module for verifying credentials of a live, remote, adjunct healthcare provider, wherein said adjunct provider is credentialed by said licensed primary healthcare provider facility, group, or individual to provide remote adjunct care for one or more patients, wherein said adjunct provider is covered by medical malpractice insurance, wherein said patients are legally under the care of said licensed primary healthcare provider facility, group, or individual;
(ii) a software module for providing said remote adjunct healthcare provider access to one or more electronic health records for said one or more patients; wherein said electronic health records are historic and/or live; and
(iii) a software module for creating and maintaining a communications link between said remote adjunct healthcare provider and said patient or one or more onsite patient caregivers.
